(19) United States
(12) Patent Application Publication
(10) Pub. No.: US 2026/0114373 A1
(43) Pub. Date: Apr. 30, 2026

(54) DEVICES SYSTEMS AND METHODS FOR DETECTING AND ADDRESSING WORK MACHINE CONDITIONS

(71) Applicant: Deere & Company, Moline, IL (US)

(72) Inventors: Scott N. Clark, Bettendorf, IA (US); Ashraf Qadir, Ankeny, IA (US); Anand Yogendra Pathak, West Des Moines, IA (US)

(21) Appl. No.: 18/932,047

(22) Filed: Oct. 30, 2024

(51) Int. Cl. A01D 41/14; A01D 41/127

(52) U.S. Cl. CPC A01D 41/141; A01D 41/127; A01D 41/144

(57) ABSTRACT

The present disclosure includes devices methods and systems related to detecting header deployment in a work machine. The method may include receiving one or more header deployment indicators from one or more header deployment sensors. The method may include determining a desired header deployment state. The method may include determining one or more desired header deployment adjustments based at least in part on the desired header deployment state and the one or more header deployment indicators. The method may include initiating a header deployment corrective action.

### FIELD OF THE DISCLOSURE

The present description relates to work machines and, in particular, to systems and methods for detecting and addressing conditions related to agricultural work machines.

### BACKGROUND OF THE DISCLOSURE

There are a variety of different types of work machines. Some work machines include agricultural machines, which may include combine harvesters, sugar cane harvesters, cotton harvesters, self-propelled forage harvesters, produce harvesters, and windrowers. During various operations, agricultural work machines may encounter undesired conditions impacting performance and quality of the operation.

### SUMMARY

The present disclosure may include one or more of the following aspects and/or combinations thereof. Some examples include a method for detecting header deployment in a work machine. The method includes receiving one or more header deployment indicators from one or more header deployment sensors. The method includes determining a desired header deployment state. The method includes determining one or more desired header deployment adjustments based at least in part on the desired header deployment state and the one or more header deployment indicators. The method includes initiating a header deployment corrective action. In some examples, the header deployment corrective action includes adjusting header deployment to one or more header deployment positions based at least in part on the one or more desired header deployment adjustments. In some examples, the header deployment corrective action includes initiating an alert. In some examples, the header deployment corrective action includes deactivating header component motion. In some examples, the one or more header deployment indicators includes image data. In some examples, determining the header deployment state further includes sensing the deployment state in a stowed position or a deployed position by one or more sensors. In some examples, receiving the one or more header deployment indicators includes receiving indication of one or more obstructions. In some examples, adjusting header deployment includes activating one or more of a header closing mechanism and a header extension mechanism. In some examples, adjusting header deployment includes laterally folding the header. In some examples, adjusting header deployment includes folding the header in a fore-aft direction.

Some examples include a system for detecting header deployment in a work machine, the system includes one or more controllers configured to receive one or more header deployment indicators from one or more header deployment sensors, determine a desired header deployment state, determine one or more desired header deployment adjustments based at least in part on the desired header deployment state and the one or more header deployment indicators, and initiate a header deployment corrective action. In some examples, the header deployment corrective action includes adjusting header deployment to one or more header deployment positions based at least in part on the one or more desired header deployment adjustments. In some examples, the header deployment corrective action includes initiating an alert. In some examples, the header deployment corrective action includes deactivating header component motion. In some examples, the one or more header deployment indicators includes image data. In some examples, to determine the header deployment state further includes to optically sense the deployment state in a transport position or a deployed position. In some examples, to receive the one or more header deployment indicators includes to receive indication of one or more obstructions. In some examples, to adjust header deployment includes to activate one or more of a header closing mechanism and a header extension mechanism. In some examples, to adjust header deployment includes to laterally fold the header. In some examples, to adjust header deployment includes to fold the header in a fore-aft direction.

### BRIEF DESCRIPTION OF THE DRAWINGS

The above-mentioned aspects of the present disclosure and the manner of obtaining them will become more apparent and the disclosure itself will be better understood by reference to the following description of the examples of the disclosure, taken in conjunction with the accompanying drawings, wherein:

FIG. 1 is a side view of an example work machine configured to harvest and process crop in a worksite;

FIG. 2 is a diagrammatic view of an example control system for the work machine;

FIG. 3 is a diagrammatic view of an example offboard control system for the work machine;

FIG. 4 is a diagrammatic view of the work machine during an agricultural operation;

FIG. 5 is a flow diagram showing an example method for detecting stall error state in a work machine;

FIG. 6 is a flow diagram showing an example method for detecting lost crop in a work machine operation;

FIG. 7 is a flow diagram showing an example method for detecting draper belt tears in a work machine;

FIG. 8 is a flow diagram showing an example method for detecting header misalignment in a work machine;

FIG. 9 is a flow diagram showing an example method for detecting header deployment in a work machine.

### DETAILED DESCRIPTION

The examples of the present disclosure described below are not intended to be exhaustive or to limit the disclosure to the precise forms in the following detailed description. Rather, the examples are chosen and described so that others skilled in the art may appreciate and understand the principles and practices of the present disclosure.

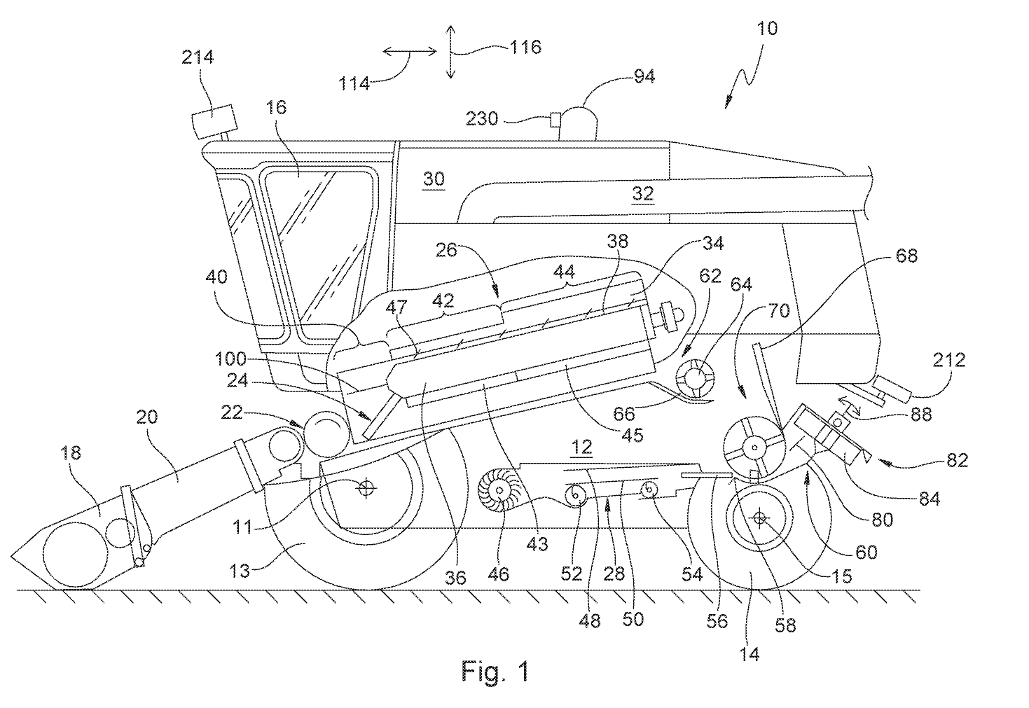

In FIG. 1, an example of a work machine 10 is shown (e.g., an agricultural machine such as a combine harvester). The work machine 10 includes a chassis 12, one or more of front ground engaging mechanisms 13, and one or more of rear ground engaging mechanisms 14. The front and rear ground engaging mechanisms 13, 14 may be wheels or tracks that are in contact with an underlying ground surface and support the chassis 12 above the ground. In the illustrative example, the front ground engaging mechanisms 13 are coupled to a front axle 11 that extends laterally, and the rear ground engaging mechanisms 14 are coupled to a rear axle 15 that extends laterally. The front and rear axles 11, 15 each have respective centerlines, which, in the illustrative example, are defined as the axial midpoints of thereof, where the axial direction is shown by the double-headed arrow 114 in FIG. 1. In the illustrative example, the axial direction and the lateral direction are perpendicular to one another. As shown in FIG. 1, the double headed arrow 116 represents the vertical direction, which in the illustrative example, is perpendicular to the axial and lateral directions.

In the illustrative example, the ground engaging mechanisms 13, 14 are coupled to the chassis 12 and are configured to rotate to move the work machine 10 in a forward operating direction (which is to the left in FIG. 1) and in other directions. In some examples, operation of the work machine 10 is controlled from an operator’s cab 16. The operator’s cab 16 may include any number of controls for controlling the operation of the work machine 10, such as a user interface 220. In some examples, various aspects related to performance of the work machine 10 may be detected to determine various work machine 10 conditions such as undesired header conditions, non-ingested crop, draper belt tears, harvest misalignment, and/or undesired header fold and/or unfold conditions.

In some examples, the controller 202, 302 may determine various work machine characteristics and environmental attributes which may contribute to undesired work machine conditions. The controller 202, 302 may determine the work machine characteristics and/or environmental attributes based at least in part on sensor data related to the work machine 10. In some examples the controller 202, 302 may determine various factors such as environmental conditions, position of the work machine 10, operating terrain of the work machine (e.g., slope, pitch, roll, etc.), soil firmness, and/or ambient attributes (e.g., dewpoint, and/or humidity). In some examples, the controller 202, 302 may determine the presence of substantially fixed field features such as a field boundary, field road, ditch, waterway, and/or terrace. In some examples, the controller 202, 302 may determine substantially movable non-crop objects such as rocks, tile, power poles, tree lines, other machines, and/or irrigation ruts. In some examples, such as in examples where the work machine 10 is a combine harvester, the controller 202, 302 may determine crop conditions such as plant height, plant state, plant population, plant type, biomass yield, mechanics, presence of weeds, intensity of weeds (e.g., size, amount, and/or material consistency of weeds) and/or type of weeds. In some examples the controller 202, 302 may determine that a state of plants in agricultural field may alternatively or additionally affect the work machine. In some examples, the controller 202, 302 may determine that the work machine 10 may be affected in one or more ways by interacting with a plant that may be standing, down, partially down, leaning, harvested and/or uniform/non-uniform crop.

In some examples, the controller 202, 302 may determine performance of the work machine based at least in part on various performance attributes. In some examples, the controller 202, 302 may determine feed rate, machine speed, height and uniformity of stubble (e.g., variance and/or flagging), material flow including feeding and/or gathering of material within the work machine 10, convergence of material within the work machine 10, unthreshed crop that was engaged with the work machine 10 but lost, missed, or thrown, processed crop length, vibration, distance traveled by the work machine, or other aspects related to performance of the work machine. In some examples, the controller 202, 302 may determine various machine attributes of the work machine 10, which may indicate undesired conditions. For example, the controller 202, 302, may determine heading of the work machine 10, speed setpoint, a header height and/or orientation (e.g., lateral tilt, fore-aft tilt), auger/belt speed, reel height, reel fore-aft position, reel speed, and/or reel finger timing, top auger position and/or speed, backshaft speed, and/or feed drum/auger height and/or finger timing.

In some examples, such as in examples related to determination of underfeeding crop, the controller 202, 302 may determine one or more aspects alternatively or in addition to the aspects described above, which may contribute to an undesired condition for the work machine 10. For example, controller 202, 302 may determine precipitation states such as ice, snow, and/or liquid, which may further be detected and determined to contribute to an undesired operational condition.

In some examples, such as in examples related to detecting draper belt tears, the controller 202, 302 may determine one or more aspects alternatively or additionally to the aspects described above that may contribute to an undesired condition for the work machine 10. For example, light intensity and/or angle may be detected (e.g., day, night, amount/intensity, direction and/or angle of light distributed on operating environment) may contribute to wear of the draper belt and/or obstruction of detection of draper belt conditions. The controller 202, 302 may also determine performance aspects such as environmental temperatures, surface temperatures, and internal temperatures (e.g., battery cells, cab, etc.) related to the draper belt. The controller 202, 302 may also determine projected longevity and/or life of components such as the belt and filters (e.g., wear resistance, wear, projected life, etc.) based at least in part on sensed data and/or pre-determined data.

In some examples, such as in examples related to detecting undesired header folding conditions, the controller 202, 302 may determine one or more aspects alternatively or additionally to the aspects described above that may contribute to an undesired operational condition. For example, the controller 202, 302 may determine an auger position (e.g., whether in an in or out position) and/or a percentage that the auger has been extended. The controller 202, 302 may further determine an underloader state whether on or off. The controller 202, 302 may further determine machine aspects such as mass, and physical dimensions as well as function and/or mode of the work machine 10 and/or components of the work machine 10. Further, the controller 202, 302 may determine whether portions of the header of the work machine 10 are on, off, down, disabled (e.g., lights entire vehicle, header etc.) and whether portions of the work machine 10 are folded and/or unfolded. In some examples, operation of the work machine 10 may be conducted by a human operator in the operator’s cab 16, a remote human operator, or an automated system.

A cutting head 18 is disposed at a forward end of the work machine 10 and is configured to harvest crop and to conduct harvested crop to a slope conveyor 20. The term harvested crop as used herein includes grain (e.g., corn, wheat, soybeans, rice, oats) and material other than grain (MOG). The cutting head 18 may be an auger platform, a draper, a belt pick-up assembly, a corn head, a cutting platform with a reel assembly, or any other cutting head configured to harvest crop in a worksite. In some examples including a draper head, upon receiving the harvested crop from the cutting head 18, the slope conveyor 20 conducts the harvested crop to a guide drum 22. The guide drum 22 guides the harvested crop to an inlet 24 of a threshing assembly 26, as shown in FIG. 1. In the illustrative example, various sub-systems of the work machine 10, such as the threshing assembly, a clean crop routing assembly 28, a crop debris routing assembly 60, and a residue assembly 82, cooperate to process the harvested crop.

The threshing assembly 26 includes a housing 34 and one or more threshing rotors. A single threshing rotor 36 is shown in FIG. 1. The threshing rotor 36 includes a drum 38 arranged along a threshing axis 100, and the threshing rotor 36 rotates about the threshing axis 100. The threshing assembly 26 further includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44. The threshing assembly 26 further includes a thresher basket 43 that is positioned in the threshing section 42 and below the threshing rotor 36, guide vanes 47 that are positioned above the threshing rotor 36, and a separating grate 45 that is positioned in the separating section 44 and below the threshing rotor 36. In the illustrative example, the guide vanes 47 guide harvested crop rearwardly through the threshing assembly 26, and the harvested crop is separated and expands as it engages with the guide vanes 47. Harvested crop falls through the thresher basket 43 and through the separating grate 45.

The harvested crop may be directed to the clean crop routing assembly 28 with a blower 46 and sieves 48, 50 with louvers. The sieves 48, 50 may be oscillated axially. The clean crop routing assembly 28 removes MOG and guides grain over a screw conveyor 52 to a grain elevator 94. The grain elevator 94 deposits the grain in a grain tank 30, as shown in FIG. 1. In some examples, the work machine 10 includes a sensor 230 that is, for example, positioned on the grain elevator 94 and configured to measure a grain yield of the harvested crop. In the illustrative example, the yield sensor 230 measures the force of the grain contacting the sensor 230 to determine the yield. The grain in the grain tank 30 may be unloaded by means of an unloading screw conveyor 32 to a grain wagon, trailer, or truck, for example.

Harvested crop remaining at a rear end of the sieve 50 is again transported to the threshing assembly 26 by a screw conveyor 54 where the harvested crop is reprocessed by the threshing assembly 26. Harvested crop remaining at a rear end of the sieve 48 is conveyed by an oscillating sheet conveyor 56 to a lower inlet 58 of a crop debris routing assembly 60. Harvested crop at the threshing assembly 26 is processed by the separating section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw rearwardly. A wall 68 is located to the rear of the ejection drum 64 and guides the straw into an upper inlet 70 of the crop debris routing assembly 60. In the crop debris routing assembly 60, blades of a rotatable chopper interact with knives to chop the straw into smaller harvested crop residue.

Harvested crop residue moves from the crop debris routing assembly 60 to the residue assembly 82 for optional subsequent processing and ejection from the work machine 10. For example, as shown in FIG. 1, the residue assembly includes one or more spreaders provided downstream of an outlet 80 of the crop debris routing assembly 60. One spreader 84 is shown in FIG. 1. Rotation of blades of the spreader 84 about an axis 88 spreads the chopped straw as the chopped straw exits the work machine 10. The work machine 10 may include one or more sensors 210, 212, 214, such as a camera, that may be positioned on the work machine (e.g., atop, underneath, at the at the front or rear end of the work machine 10) and configured capture one or more images of a field of view disposed about the work machine (FOV). The FOV may include one or more portions of an agricultural field and/or portions of the work machine (e.g., the header).

In some examples, the one or more sensors of the work machine 10 include one or more image sensors configured to capture one or more images of the FOV external to the work machine 10 (e.g., portions of the work machine and/or field disposed about the work machine). In FIG. 1, the one or more image sensors 210, 212, 214 may be a camera. However, in some examples, the one or more image sensors 210, 212, 214 alternatively or additionally may be various sensors (e.g., optical or visual radiation cameras or red, green, blue (RGB) cameras), LiDAR sensors, radar sensors (e.g., long-range terahertz radar, mm wave radar, ultra-wideband radar, frequency-modulated continuous wave radar (FMCW), ground penetrating radar), ultrasonic sensors, thermal sensors (e.g., a thermal cameras), stereo cameras, laser vibrometers, infrared nuclear magnetic resonance (NMR) cameras, infrared short-wave infrared (SWIR) cameras, infrared terahertz sensors, or other sensors operable to capture or generate one or more images or data corresponding to the one or more images of the field of view. It should be appreciated that while an exemplary work machine 10 is described with reference to FIG. 1, aspects of the disclosure (e.g., the control system and methods herein) are applicable to various work machines such as agricultural machines configured to harvest crop.

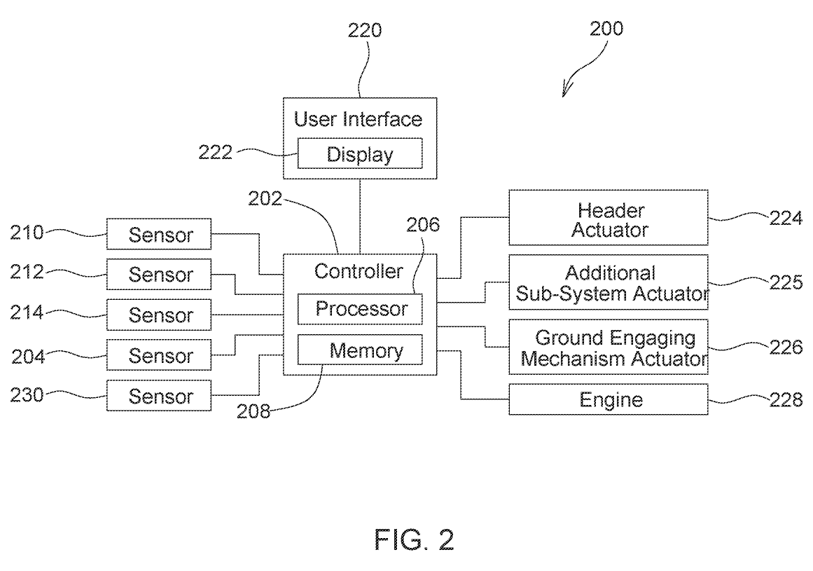

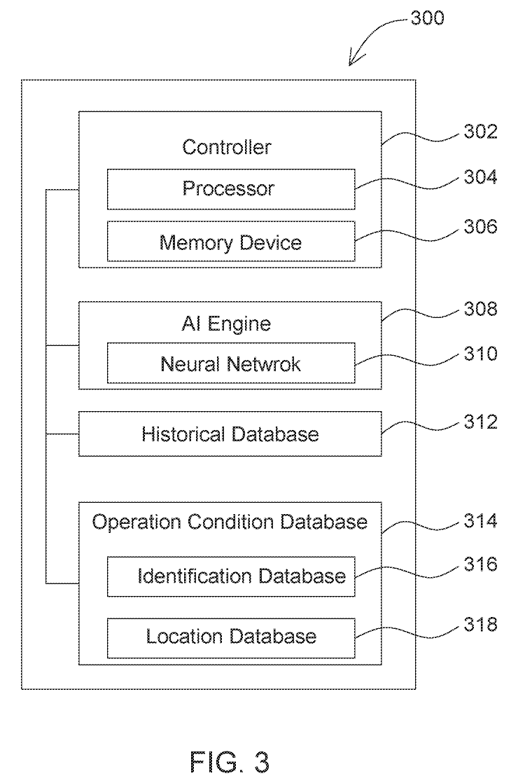

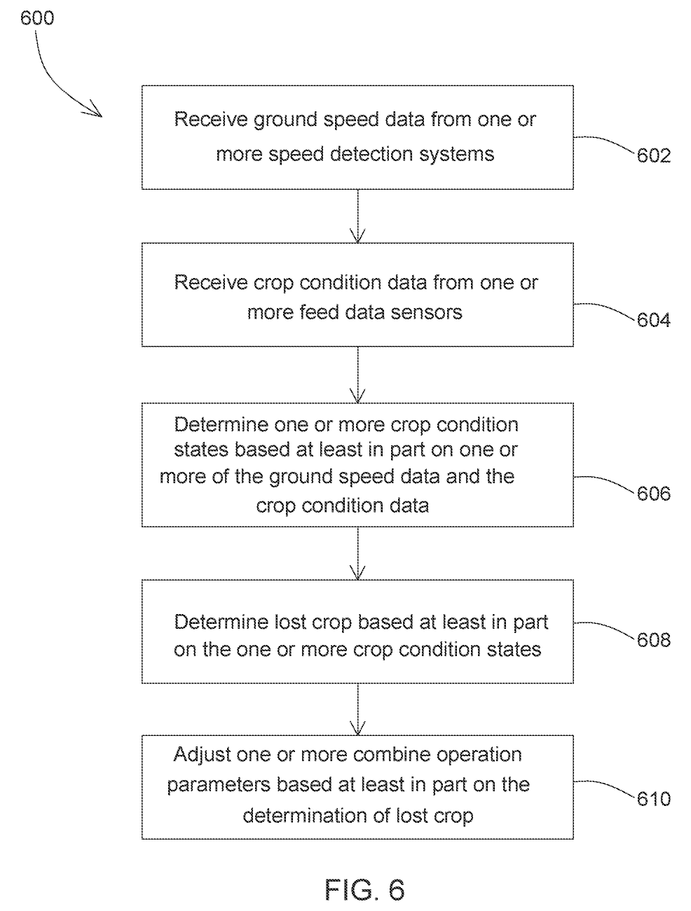

Referring now to FIG. 2, an example control system 200 is shown. The control system 200 includes one or more memories 208 included in or accessible by the controller 202 and one or more processors 206 included in or accessible by the controller 202. The control system may be a central control system that may be utilized to implement various functions related to the work machine 10. For example, the control system 200 may at least in part implement one or more of the processes described below with respect to FIGS. 6-9. The one or more processors 206 are configured to execute instructions (e.g., one or more algorithms) stored on the one or more memories 208. The controller 202 may be a single controller or a plurality of controllers operatively coupled to one another. The controller 202 may be positioned on the work machine 10 or positioned remotely, away from the work machine 10. In some examples, the control system 200 may operate independently, or in conjunction with other control systems such as an AI based control system (e.g., see FIG. 3).

The controller 202 may be coupled via a wired connection or wirelessly to other components of the work machine 10 and to one or more remote devices. In some instances, the controller 202 may be connected wirelessly via Wi-Fi, Bluetooth, Near Field Communication, or another wireless communication protocol to other components of the work machine 10 and to one or more remote devices.

Referring still to FIG. 2, in the illustrative example, the controller 202 is operatively coupled to at least one sensor 204, the at least one sensor 210, 212, 214, 230. In the illustrative example, the controller 202 is configured to receive data corresponding to the one or more images of the field of view (e.g. FOV) from the one or more image sensors 210 and data corresponding to the one or more images of the additional fields of view from the image sensors 212, 214.

Referring still to FIG. 3, in some examples, the controller 202 is operatively coupled to a display, for example, the display 222 of the user interface 220, and configured to send one or more signals to the display based on a determination of an amount of grain shown in one or more images of the field of view. In the illustrative example, the controller 202 is operatively coupled to the user interface 220 and configured to receive one or more signals from the user interface 220, which may include inputs for operational characteristics of the work machine 10 (e.g., speed of the work machine 10, direction of the travel of the work machine 10, operational characteristics of the cutting head 18, operational characteristics of the threshing assembly 26, operational characteristics of the clean crop routing assembly 28, operational characteristics of the crop debris routing assembly 60, and operational characteristics of the residue assembly 82. Operational characteristics of the cutting head 18 include cutting head angle along axial span thereof, cutting head height relative to ground, cutting head speed, reel speed, reel position, reel tine angle, corn head deck plate spacing, draper belt speed, cutting head down force, and lateral tilt of cutting head. Operational characteristics of the threshing assembly 26 include threshing rotor speed, position of the thresher basket relative to the threshing rotor, and guide vane orientation. Operational characteristics of the clean crop routing assembly 28 include blower speed and sieve position. Operational characteristics of the crop debris routing assembly 60 include chopper speed and position of the knives relative to the chopper. Operational characteristics of the residue assembly 82 include spreader speed and spreader orientation.

In some examples, the operational characteristics of the work machine 10 are input by a user via the user interface 220 based on the displayed determination of the amount of grain shown in the one or more images of the field of view. It should be appreciated that in some examples, the controller 202 is configured to adjust one or more of the operational characteristics of the work machine 10 automatically (e.g., based on a determination of an amount of grain shown in one or more images of the field of view and without instruction from the user interface 220).

Referring still to FIG. 3, in some examples, the controller 202 is operatively coupled to at least one header actuator 224, at least one ground engaging mechanism actuator 226, or both. The at least one header actuator 224 and the at least one ground engaging mechanism actuator 226 may each include at least one of a control valve, a motor, a linear (e.g., cylindrical) actuator, a rotary actuator, or another actuator configured to cause adjustment of an operational characteristic of the work machine 10. As shown in FIG. 3, in some examples, the controller 202 is operatively coupled to an engine 228 of the work machine 10 and configured send one or more signals to the engine 228 to adjust the speed of the work machine 10. In some examples, the controller 202 is operatively coupled to one or more additional sub-system actuators 225 (e.g., control valves, motors, linear actuators, rotary actuators), configured to cause adjustment of one or more operational characteristics the threshing assembly 26, the clean crop routing assembly 28, the crop debris routing assembly 60, and the residue assembly 82.

In some examples, the control system 200 may include and/or be communicatively coupled to an offboard/offboard condition detection system 300. FIG. 3 shows an architecture for an onboard/offboard condition detection system 300 that includes a controller 302 having a processor 304 and a memory device 306 (which may be the same as, alternative, or in addition to the controller 202). The onboard/offboard condition detection system 300 may include an artificial intelligence (AI) engine 308 that may include a neural network 310. By being at the onboard/offboard condition detection system 300, information collected by a plurality of agricultural vehicles may be used to train, and retrain, one or more machine learning models, including algorithms, of the neural network 310. According to certain examples, the machine learning model(s), and, optionally, updates to such models, may be communicated to the controller 202 of the work machine 10, and stored at the work machine 10, including by the memory device 208. Alternatively, or additionally, the AI engine 308 and neural network 310 may be located at the work machine 10 and communicatively coupled to the controller 202.

The neural network 310 may employ machine learning models, including algorithms, designed to enhance the precision and efficiency of detecting unwanted work machine conditions. As discussed below, such machine learning models may be used to determine and/or adjust one or more detection of undesired conditions. Further, various detection methods and/or routines may also be determined via use of the machine learning model(s). Alternatively or additionally, the various detection methods/routines may be based on operator preferences or derived by the machine learning model(s) in view of operator preferences. According to some examples, such work machine conditions may correspond to default settings.

According to certain examples, the architecture of the neural network 310 may include one or more input layers that may process raw information, including data, from one or more sensors 204, 210, 212, 214, 230 and identified operator preferences, among other information. The neural network 310 may further include multiple hidden layers of interconnected neurons that may process inputted information, such as input data, including applying nonlinear transformations to extract complex patterns and relationships within the information. For example, the hidden layers may employ activation functions to introduce non-linearity and improve the ability of the neural network 310 to model intricate dependencies. The neural network 310 may further include an output layer that may generate information for guiding, and/or adjusting, one or more of the position, orientation, and speed of the work machine 10. The output layer may further generate information for controlling various other functions of the work machine, e.g., actuation of various work machine components (e.g., component actuators).

The machine learning model(s) of the neural network 310 may be trained, and/or retrained, in a variety of manners, including, for example, via supervised learning, adaptive learning, and/or generative models. For example, with respect to supervised learning, historical information, as may be stored in a historical database 312, may include labeled examples of prior agricultural operations that at least attempted to successfully complete an agricultural function, and may utilize, for example, optimization models, such as, for example, Gradient Descent or Adam Optimizer, for minimizing the error between predicted and actual outcomes. With respect to adaptive learning, the neural network 310 may, for example, continue to learn adaptively from at least near real-time information, including, for example, information provided by one or more sensors 204, 210, 212, 214, 230, and refine the accuracy or efficiency of the machine learning model via updating applied weights based on feedback information. With respect to generative machine learning models, the neural network 310 may, for example, simulate various agricultural operation, based on existing data to forecast potential difficulties, and devise strategies to mitigate those difficulties.

The onboard/offboard condition detection system 300 may include a plurality of databases 312, 314, 316, 318 that may store a variety of different types of historical, operator preference, and/or identification information that may be used in the training, or retraining, of the machine learning model(s) of the neural network 310. For example, the onboard/offboard condition detection system 300 may include a historical database 312 that may store information regarding past commands generated by a machine learning model(s) of the neural network 310 in connection with prior agricultural operation. For example, the historical database 312 may include information regarding past commands that involved Determination of and/or addressing undesired work machine conditions. Thus, the historical database 312 may also include, among other types of information, records of past specific adjustments made to the speed, orientation, and/or heading of the work machine 10, among other parameters, during one or more undesired condition detection based on one or more determinations outputted by the machine learning model(s) of the neural network 310.

The historical database 312 may also include feedback information relating to prior agricultural operation that utilized one or more determinations based on an output from the machine learning model of the neural network 310. Such feedback information may include, for example, information obtained from one or more sensors 204, 210, 212, 214, 230 during previous agricultural operations, one or more of detecting a stall error state, detecting lost crop in a work machine operation, detecting draper belt tears in a work machine 10, detecting header misalignment, and detecting header deployment in a work machine 10, as may be provided by one or more of a plurality of sensors communicably couplable to the work machine 10. The feedback information may also include adjustments made by the operator, or other systems, to one or more operations of the work machine 10 that had been based on information from the machine learning model of the neural network 310, as well as other potential variables that may be present in connection with those operator initiated adjustments, including, for example, terrain information, crop information, and/or machine health information as may be indicated by a plurality of sensors.

The feedback information stored by the historical database 312 may also include performance metrics that may provide an indication of the success, or lack thereof, of agricultural operations, including, with respect to data indicating machine health conditions, terrain conditions, and/or crop conditions.

The historical database 312 may also include ancillary information that may impact the work machine 10 when during an agricultural operation. For example, such ancillary information may include information regarding environmental conditions during past operations, such as, for example, soil moisture content and/or precipitation levels that may impact the interaction of the work machine 10 with the ground that may impact the performance or operation including, for example, influence the turning, stopping, and/or speed adjustments of the work machine 10. In some examples, ancillary information may include information regarding machine conditions that may influence operation of the work machine 10 such as conditions of one or more parts of the work machine 10 during various portions of the process.

Information provided by the historical database 312 may enable the neural network 310 to leverage agricultural operations to optimize future agricultural operations, including optimizing the travel parameters associated with different distance thresholds. By analyzing patterns identified by the neural network 310 from at least the information stored by the historical database 312, among other information, the neural network 310 may refine the machine learning model(s) to enhance predictive accuracy and improve the efficiency of work machine operations, including with respect to the machine operation and field parameters obtained via use of the machine learning model(s) for different travel states, as discussed above. The historical database 312 may also support the above-discussed adaptive learning by allowing the neural network 310 to update its models in real-time based on information collected, for example, from the one or more sensors 204, 210, 212, 214, 230 and/or from operator inputs via the user interface 220 during ongoing operations. Such a continuous learning process may assist the detection and adjustments related to unwanted conditions by the work machine 10 during the agricultural operations being adapted to varying conditions and operator preferences.

The onboard/offboard condition detection system 300 may also include one or more databases, such as, for example, an operation condition database 314, that may include various information regarding at least the work machine 10, among other work machines, that is to be involved in a current or upcoming agricultural operation. The particular work machine for which information stored in the operation condition database 314 is to be retrieved, and/or used, in connection with a work machine operation, including a current or upcoming work machine operation, may be identified in a variety of manners. For example, according to certain examples, the work machine 10 that is, or will be, involved in the agricultural operation, and for which information is to be retrieved, may be identified via an operator inputting one or more identifiers for the work machine 10 via use of an input device (e.g., the user interface 220). Additionally, according to certain examples, one or more of the sensors 204, 210, 212, 214, 230 may capture information, including images, from which unique features of the work machine 10 an/or field may be extracted. Such extracted information may include identification codes, symbols, or tags, and/or involve the controller 302, analyzing a corresponding shape and/or size of the work machine 10, or portion thereof, from the captured information.

The operation condition database 314 may store a diverse range of information regarding operational conditions that may facilitate a work machine operation such as an agricultural operation. For example, the operation condition database 314, including an identification database 316, may store an identification of a work machine component type, such as, for example, a header type, and at least certain physical dimensions of the work machine 10. In some examples, the identification database, may store identification information for crop types as well as non-crop objects that may be in an agricultural field.

The operation condition 314, including a location database 318, may store information regarding the recorded location of various work machine conditions and/or field conditions. Moreover, the location database 318 may include, for example, coordinates (e.g., latitude and longitude), among other location information, of the work machine 10, or portions thereof. Such information may further assist in determining operation parameters for attaining a work machine operation such as an agricultural operation. While the foregoing discussed information that may be stored in the operation condition database 314, including the identification and location databases 316, 318, such information, or similar information, may also include the memory device 208.

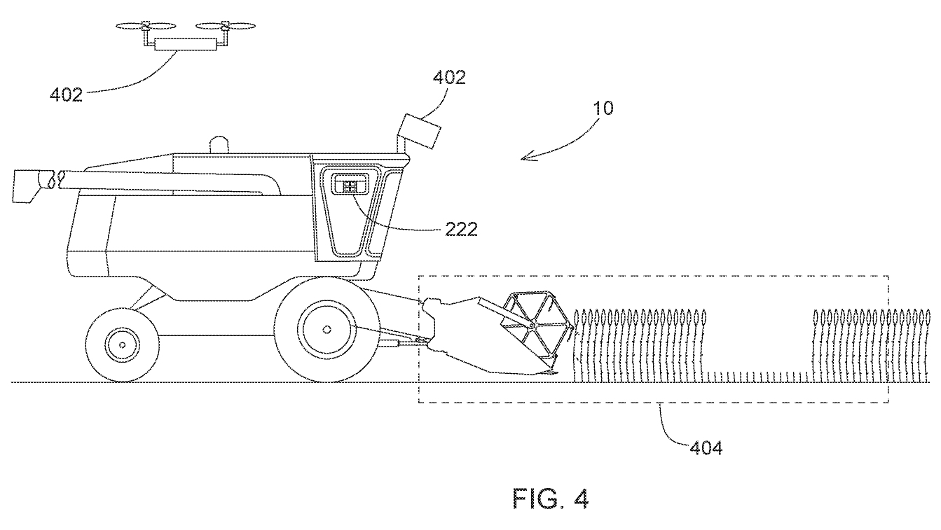

FIG. 4 shows an example of the work machine 10 during an agricultural operation. The work machine 10 includes a plurality of sensors 402 for work machine operation and/or automation. The plurality of sensors may be one or more of onboard work machine mounted sensors and/or offboard sensors (e.g., drone, satellite, etc.). The sensors 402 may be the same or similar to sensors described with respect to FIG. 2 (e.g., sensors 210, 212, 214). The work machine 10 may utilize the one or more sensors before, during and/or after operation. For example, the work machine 10 may utilize one or more of the sensors 402 to determine grain harvest quality, terrain, or position with respect to crop or non-crop objects. In some examples, the work machine 10 may alternatively or additionally utilize one or more of sensors 402 to determine various aspects with respect to the operation and/or condition of the work machine 10. During a work machine operation, the work machine 10 may be oriented in a desired direction of travel. The work machine 10 may include onboard sensors that are configured to determine work machine condition and agricultural field condition with respect various coordinate systems such as the direction of travel.

In some examples, one or more sensors 402 of the work machine 10 may be configured to monitor and/or detect one or more FOVs 404 disposed about desired portions of the work machine. The desired one or more FOVs 404 may be one or more portions of a field or the work machine that may be monitored for data related to work machine operation. For example, the one or more sensors 402 may be configured to provide optical data regarding portions of an area about a desired portion of the work machine (e.g., behind the header, or immediately adjacent/under the combine).

Various conditions may arise during operation of a work machine, in which a user may desire to identify and/or provide responsive action related to one or more conditions. For example, the work machine 10 and/or a portion of the work machine 10 may enter into an error state such that one or more functions of the header do not operate as desired (e.g., stall, plugging, etc.). In some examples, during some harvesting operations, crop may be severed but not ingested by a combine. In some examples where the work machine 10 is a combine harvester, the combine harvester may include a draper belt. In some such examples, the draper belt may change condition to an undesired condition before, during, or after operation (e.g., tears, rips, stretching, misalignment, holes, burns, deformation).

In some examples, the operation of an agricultural combine harvester may cause the combine harvester to be misaligned with the crop. For example, a harvesting width or row spacing of the combine harvester may not match a width or row spacing of crop planted by a planter during a seeding process. As such, the differentiating widths or spacing may cause a combine harvester to miss a portion of crop during a pass of an agricultural operation. In some examples, conditions may also arise regarding stowing and deploying portions of a combine harvester. In some examples, the work machine 10 may fold and/or unfold a header in an undesired way or not at all. In some such examples as described above, various methods and systems may be used to detect such conditions and adjust the operation of the work machine 10 to cause the work machine 10 to operate in a desired way. In some examples, various aspects related to performance of the work machine 10 may be detected to determine various work machine 10 conditions such as undesired header conditions, non-ingested crop, draper belt tears, harvest misalignment, and/or undesired header fold and/or unfold conditions.

In some examples, the controller 202, 302 may determine various work machine characteristics and environmental attributes which may contribute to undesired work machine conditions. The controller 202, 302 may determine the work machine characteristics and/or environmental attributes based at least in part on sensor data related to the work machine 10. In some examples the controller 202, 302 may determine various factors such as environmental conditions, position of the work machine 10, operating terrain of the work machine (e.g., slope, pitch, roll, etc.), soil firmness, and/or ambient attributes (e.g., dewpoint, and/or humidity). In some examples, the controller 202, 302 may determine the presence of substantially fixed field features such as a field boundary, field road, ditch, waterway, and/or terrace. In some examples, the controller 202, 302 may determine substantially movable non-crop objects such as rocks, tile, power poles, tree lines, other machines, and/or irrigation ruts. In some examples, such as in examples where the work machine 10 is a combine harvester, the controller 202, 302 may determine crop conditions such as plant height, plant state, plant population, plant type, biomass yield, mechanics, presence of weeds, intensity of weeds (e.g., size, amount, and/or material consistency of weeds) and/or type of weeds. In some examples the controller 202, 302 may determine that a state of plants in agricultural field may alternatively or additionally affect the work machine. In some examples, the controller 202, 302 may determine that the work machine 10 may be affected in one or more ways by interacting with a plant that may be standing, down, partially down, leaning, harvested and/or uniform/non-uniform crop.

In some examples, the controller 202, 302 may determine performance of the work machine based at least in part on various performance attributes. In some examples, the controller 202, 302 may determine feed rate, machine speed, height and uniformity of stubble (e.g., variance and/or flagging), material flow including feeding and/or gathering of material within the work machine 10, convergence of material within the work machine 10, unthreshed crop that was engaged with the work machine 10 but lost, missed, or thrown, processed crop length, vibration, distance traveled by the work machine, or other aspects related to performance of the work machine. In some examples, the controller 202, 302 may determine various machine attributes of the work machine 10, which may indicate undesired conditions. For example, the controller 202, 302, may determine heading of the work machine 10, speed setpoint, a header height and/or orientation (e.g., lateral tilt, fore-aft tilt), auger/belt speed, reel height, reel fore-aft position, reel speed, and/or reel finger timing, top auger position and/or speed, backshaft speed, and/or feed drum/auger height and/or finger timing.

In some examples, such as in examples related to determination of underfeeding crop, the controller 202, 302 may determine one or more aspects alternatively or in addition to the aspects described above, which may contribute to an undesired condition for the work machine 10. For example, controller 202, 302 may determine precipitation states such as ice, snow, and/or liquid, which may further be detected and determined to contribute to an undesired operational condition.

In some examples, such as in examples related to detecting draper belt tears, the controller 202, 302 may determine one or more aspects alternatively or additionally to the aspects described above that may contribute to an undesired condition for the work machine 10. For example, light intensity and/or angle may be detected (e.g., day, night, amount/intensity, direction and/or angle of light distributed on operating environment) may contribute to wear of the draper belt and/or obstruction of detection of draper belt conditions. The controller 202, 302 may also determine performance aspects such as environmental temperatures, surface temperatures, and internal temperatures (e.g., battery cells, cab, etc.) related to the draper belt. The controller 202, 302 may also determine projected longevity and/or life of components such as the belt and filters (e.g., wear resistance, wear, projected life, etc.) based at least in part on sensed data and/or pre-determined data.

In some examples, such as in examples related to detecting undesired header folding conditions, the controller 202, 302 may determine one or more aspects alternatively or additionally to the aspects described above that may contribute to an undesired operational condition. For example, the controller 202, 302 may determine an auger position (e.g., whether in an in or out position) and/or a percentage that the auger has been extended. The controller 202, 302 may further determine an underloader state whether on or off. The controller 202, 302 may further determine machine aspects such as mass, and physical dimensions as well as function and/or mode of the work machine 10 and/or components of the work machine 10. Further, the controller 202, 302 may determine whether portions of the header of the work machine 10 are on, off, down, disabled (e.g., lights entire vehicle, header etc.) and whether portions of the work machine 10 are folded and/or unfolded.

In some examples, one or more of the conditions described above may be addressed at least in part by a user, which may assess and adjust aspects of the work machine 10 to cause the work machine 10 to operate in a desired way. However, in some examples such as in some examples including autonomous work machines, conditions may not be addressed directly by a user. For example, a user may not have direct access to the work machine to identify or adjust aspects of the work machine 10 to cause the work machine 10 to operate in a desired way. As such, methods and systems to detect aspects of work machine operation and adjust work machine operation in response to the detected aspects may be beneficial. Provided herein are methods and systems for detecting undesired conditions related to a work machine and/or work machine operation.

In some examples, the work machine 10, may undergo unwanted stall conditions (e.g., slow speed or stall events). In such examples, the work machine 10 may be slowed or stalled for one or more reasons such as undesired crop ingestion, non-crop object ingestion, undesired mechanical states, and/or terrain obstructions/obstacles. In some examples, one or more components of the work machine may undergo unwanted stall conditions which affect operation of the work machine. In some examples, work machine components that may undergo unwanted stall conditions may include the header reel, material conveyance auger(s), center feed section, cutterbar, stalk rollers, gathering chains, end fenders, or other components related to work machine operation. For example, a reel of a combine harvester may undergo stalling, augers of a combine harvester may undergo plugging. The work machine 10 may detect such stall errors utilizing one or more sensors configured to identify stall states and/or causes (e.g., sensors 402). The controller 202, 302 may be further configured to provide one or more actions and/or instructions to address the one or more stall states.

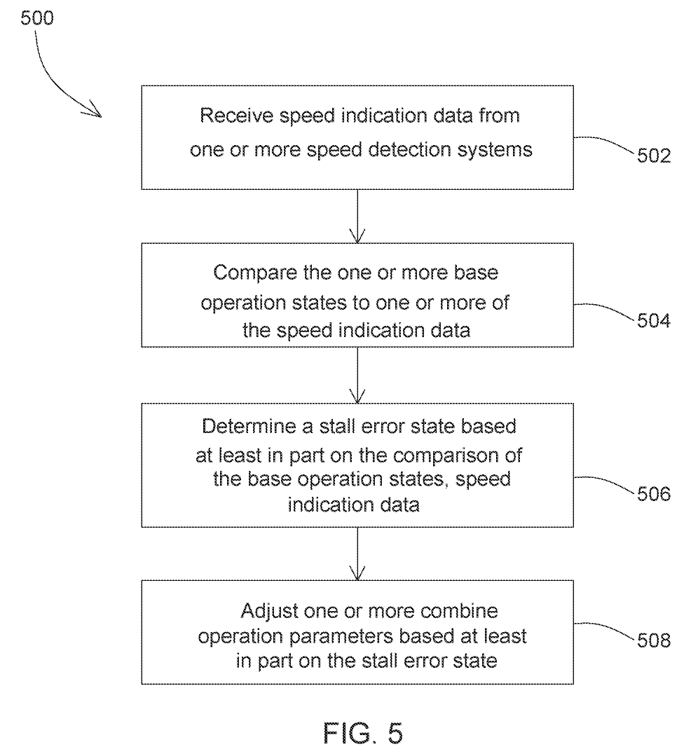

FIG. 5 is a flow chart 500 showing example steps 502-508 for detecting a stall error state in a work machine. The process may be implemented by a system for monitoring a portion of the work machine 10 and/or agricultural field, which may include one or more controllers such as one or more of the controllers 202, 302.

At step 502 the controller 202 determines one or more base operation states. The base operation states may indicate one or more desired states for one or more parameters related to work machine operation. For example, the base operation states may include a range of ground speed data indicative of desired operation conditions. The base operation states may also include ranges of one or more other work machine operation aspects such as rotating speed of rotating components such as (e.g., reel, auger, etc.) or movement speed of reciprocating components (e.g., reciprocation of cutter bar, etc.), or other ranges of movement rates of other moving components of the work machine. The one or more base operation states may be based on one or more determinations of base operation states for the work machine 10 as obtained from historical data and/or measured data. For example, the base operation states may be based at least in part on one or more repositories (e.g., databases) of data such as image data or operational statistical data. In some examples, the data may be based at least in part on data from similar operations, and/or operations in similar or the same regions, and/or locations.

At step 504, of the method, the controller 202 receives speed indication data from the one or more sensors. The speed indication data may include data related to ground speed or operation of other machine components. The speed indication data may change as the speed of the work machine 10 changes. In some examples the speed indication data is data that identifies an operating speed of a work machine 10 such as a combine. For example, the operation speed data may include ground speed data. In some examples, speed indication data may include data related to one or more machine components of the work machine 10 such as an auger rotation, cutter bar reciprocation, or other combine and/or combine header operation data that may vary in relation to the ground speed of the combine harvester.

At step 506, the controller 202, 302 compares the one or more base operation states to the speed indication data to determine a stall error state. In some examples, the stall error state may be related to an operation error during an agricultural operation. For example, the stall may be related to contact with the ground or objects, ingestion of non-crop objects, undesired ingestion of crop, mechanical misalignment, and/or other conditions and/or occurrences that may cause unwanted work machine operation during an agricultural operation. For example, the controller 202 may compare a value of a rate of change of position as taken by a GPS with similar position data (e.g., same field or geographical region). In some examples, the controller 202 may use one or more onboard speed sensor values to compare to average speed values in a similar operation. In some examples, the controller 202, may determine a comparative speed by onboard speed sensor readings based on one or more of the historical data and the current data.

At step 508, the controller 202 sends instructions to one or more systems related to the work machine to adjust one or more combine operation parameters, based at least in part on the stall error state. The stall error state may indicate combine operation errors such as clogging, undesired component function, or other aspects related to combine operation that may cause a work machine 10 to stall. For example, the controller 202, 302 may send an alert to one or more operators to make an adjustment to operation to cause the work machine 10 to move from a stalled state. In some examples, a user may send instructions remotely to change operation of the work machine 10 (e.g., stopping or starting the system, accelerating or decelerating the work machine 10, moving a component, etc.).

The work machine 10 may also send instructions to components such as the engine or actuators on the work machine 10 to cause the work machine 10 to make adjustments to remove the stalled state. For example, the controller 202, 302 may cause the work machine 10 activate or deactivate, to move a header, stop header operation, stop rotation of a rotating assembly (e.g., reel, auger, belt, etc.), stop movement of a reciprocating assembly (e.g., cutter bar), and/or start certain components of the work machine 10 to address the error state. For example, if the controller 202 receives indication that the work machine 10 is in a stalled state due to machine speed data and auger rotation speed data, the system may determine that the work machine 10 is in a stalled state due to a clogged combine. In such examples, the system may determine a combine rotation speed likely to dislodge clogged items and cause the work machine 10 to resume work outside of the error state. In some examples, the controller 202 may determine other corrective actions or combinations of actions related to the work machine 10 to remedy the error states.

In some examples, the work machine 10 may undergo conditions causing the work machine 10 to not harvest and/or to overrun downed crop without ingesting it. In such examples, the work machine 10 may be overrunning downed crop for various reasons such as undesired crop ingestion, non-crop object ingestion, undesired mechanical states, and/or terrain obstructions/obstacles. For example, the work machine 10 may overrun crop that has been severed and captured by the work machine but lost due to underfeeding and/or being dropped and/or thrown off the header. In some such examples, material may backfeed under draper belts of the header and/or wrap and discharges below the header. In some examples, header components such as end dividers may be positioned such that they cause crop to be knocked over or lodged and cause the work machine 10 to overrun crop. The work machine 10 may detect such un-ingested downed crop utilizing one or more sensors configured to identify stall states and/or causes. The controller 202, 302 may be further configured to provide one or more actions and/or instructions to address the crop overrun condition.

FIG. 6 is a flow chart 600 showing example steps 602-610 for detecting severed crop that has not been ingested into the work machine 10. The process may be implemented by a system for monitoring a portion of the work machine 10 and/or agricultural field, which may include one or more controllers such as one or more of the controllers 202, 302.

At step 602, the controller 202, 302 receives ground speed data from one or more speed detection systems. For example, the controller 202, 302 may receive speed detection data from one or more speed detection systems. For example, the controller 202, 302 may receive data from speed detection systems such as GPS data that may indicate a rate of change of the work machine 10 as during an operation. Alternatively or additionally, the controller 202, 302 may receive data from an onboard speed sensing system such as a speedometer, accelerometer, or other onboard sensor that is configured to determine a travel speed of the work machine 10.

At step 604, the controller 202, 302 receives crop condition data from one or more perception sensors that may operate as feed data sensors. For example, the crop condition data may be crop image data from one or more optical sensors such as one or more cameras, lidar, radar, or other optical sensors such as the optical sensors described throughout this application. In some examples, crop condition data may be obtained from one or more optical sensors which may be located in one or more configurations in relation to the work machine 10. For example, the perception system may be located on one or more of the work machines, satellites, drones, nearby vehicles, and/or other sensing locations that are positioned such that they may provide image data related to the work machine 10, crop feed, and/or surrounding field areas as described above.

The controller 202, 302 may also receive crop condition data from other indicators related to the work machine 10. For example, the controller 202, 302 may determine vibrations indicating downed crop interacting with the work machine 10. The controller 202, 302 may also receive data based on other operational states such as rotation speed of rotating components or reciprocal movement of reciprocating components.

In some examples, crop condition data may include data indicative of crop related to an agricultural operation. For example, the crop condition data may be data indicative of downed crop, non-feeding crop, non-harvested crop, or crop in other conditions. The crop condition data may include crop condition for crop at various locations in relation to the work machine 10. For example, the crop condition may be determined for crop in front, sides, and/or rear of a work machine 10 with respect to a direction of travel during a harvesting operation.

At step 606, the controller 202, 302 determines one or more crop condition states based at least in part on one or more of the ground speed data and the crop condition data. The crop condition states are states of crop condition in relation to the work machine 10 and/or intended work machine operation. For example, the controller 202, 302 may process the crop condition data and/or vibration data and determine if there are abnormalities in the data that may indicate that crop has been downed but is not being ingested. In some examples, the controller 202 may determine that crop has been downed based on image data, while the vibration is in a desirable range. The controller 202, 302 may determine as such that the crop is likely being ingested and the crop condition that is such that the crop is downed and ingested. In some examples, the controller 202 may determine that crop has been downed based at least in part on image data, while the vibration is in an undesirable range. The controller may further determine that crop is being left behind based at least in part on additional image data around the combine (e.g., crop images behind the header). The controller 202, 302 may determine as such that the crop is not being ingested and the crop condition that is such that the crop is downed and not ingested.

At step 608, the controller 202 determines that crop has been downed near the work machine 10 and as such may be lost in a downed but not ingested state. The controller 202 may determine the amount of lost crop based at least in part on the crop condition state. The crop condition state may indicate a rate at which downed crop is being passed by the work machine 10 based at least in part on one or more of downed crop data, and rate of travel of the work machine 10. For example, the crop condition state may be based at least in part on indications of downed crop such as work machine vibration, ingestion interruption for rotating and/or reciprocating components, and/or abnormalities regarding other components of the work machine 10 that may be disrupted or obstructed by interaction with downed crop. In some examples, the controller 202 may determine a cause of un-ingested crop based at least in part on the crop condition state. For example, the controller 202 may determine that if crop is downed but not being ingested, that the work machine 10 may have an undesired header condition or other undesired condition related to one or more other moveable portions of the system related to downed crop. For example, the header may be operating with an undesirable cutting rate and/or rate of rotation such that crop is being dropped and/or ejected from the header.

At step 610, the controller 202 adjusts one or more combine operation parameters based at least in part on the determination of lost crop. For example, the controller 202 may send an alert to one or more operators to make an adjustment to one or more operations to cause the work machine 10 to ingest crop. The work machine operation may be such that a user may make a remote or non-remote change to the system (e.g., stopping or starting the system, accelerating or decelerating the work machine 10, moving a component, etc.). In some examples, the combine operation parameters may include an alert that includes a mechanical change indicator, which indicates that a mechanical change may be desired for desired operation of the work machine 10. In some examples, the alert may include specific mechanical change types based at least in part on the crop condition data.

The controller 202 may also send instructions to the work machine 10 to adjust operation of components such as the engine or actuators of the work machine 10 to cause the work machine 10 to adjust operation to avoid missing downed crop. For example, the controller 202 may cause the work machine 10 to move, stop moving, increase movement speed and/or decrease movement speed. In some examples, the controller 202 may provide instructions to move a header, stop header operation, stop rotation of a rotating assembly, stop movement of a reciprocating assembly (e.g., cutter bar), and/or stop and/or start certain components of the work machine 10 to address the state. For example, if the controller 202 detects that the work machine 10 is in a state that will overrun downed crop due to machine speed and auger combine rotation speed, the controller 202 may determine that there is an overrun state due to a clogged combine. In such examples, the controller 202 may determine a combine rotation speed likely to dislodge obstructing items and cause the work machine 10 to resume work outside of the error state.

In some examples, the controller 202 may determine other corrective actions or combinations of actions related to the work machine 10 to cause the work machine 10 not to miss and/or overrun downed crop. For example, the controller 202 may send instructions to adjust a header cut height, mechanical position of the header and/or header components (e.g., end dividers and/or points for crop flow/orientation), header cut speed, and header down-pressure and/or downforce. In some examples including a belt, the instructions may include adjusting a belt speed. In some examples where severed crop is not ingested due to misalignment with crop rows, the corrective actions may include adjusting an orientation of a header to align at least in part with crop rows such that the header may ingest the crop.

In some examples, where the work machine 10 has one or more draper belts, the work machine 10 may undergo conditions causing undesired draper belt conditions. In such examples, the draper belt may be in a slipping condition and/or have tears, rips, deformation and/or otherwise be in an undesired condition. Undesired draper belt conditions may arise for various reasons such as interaction with undesired objects, heat, material use, and/or other conditions that may impact the condition of a draper belt. The controller may determine unwanted draper belt conditions utilizing data from one or more sensors configured to identify one or more draper belt conditions and/or causes. The controller may be further configured to provide one or more actions and/or instructions to address the one or more draper belt conditions.

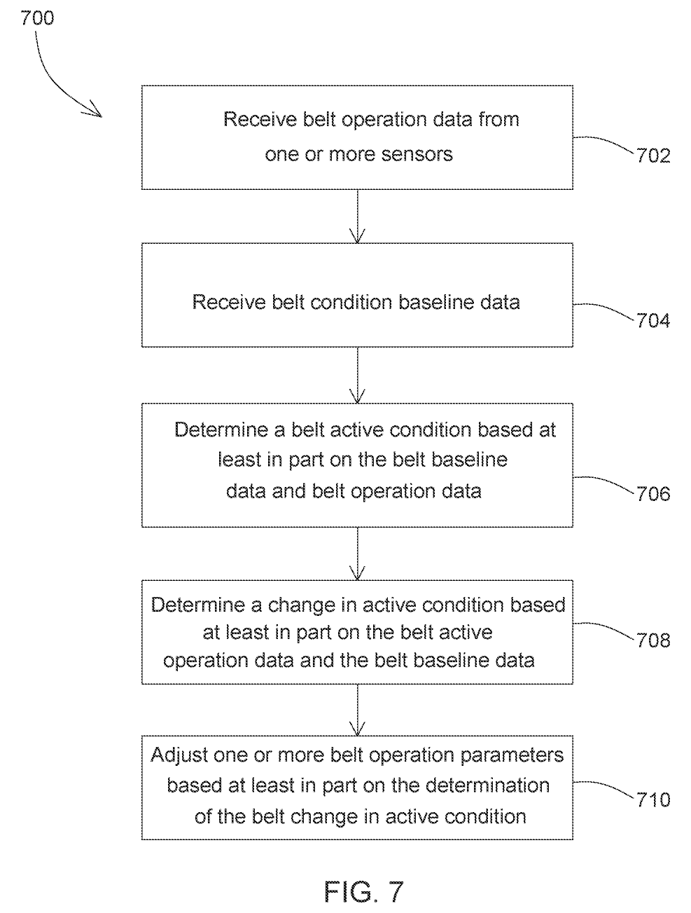

FIG. 7 is a flow chart 700 showing example steps 702-708 for detecting one or more unwanted draper belt conditions in the work machine 10. The process may be implemented by a system for monitoring a portion of the work machine 10 and/or agricultural field, which may include one or more controllers such as one or more of the controllers 202, 302.

At step 702 the controller 202 may receive belt operation data from one or more sensors. The belt operation data may be data that indicates one or more aspects of the belt operation during a present state of the work machine 10 (e.g., during an agricultural operation or in between agricultural operations). For example, the operation data may include optical data that shows images of portions of the draper belt in a present state. In some examples, the optical data may include optical data for one or more portions of a draper as the portions of the draper belt pass by an optical data sensing device such as a camera, radar, lidar, or other optical data sensing devices as described in this application. In some examples, operation data may include data related to other draper belt condition indicators. For example, operation data may include data such as rotation speed of the draper belt or vibration data from the draper belt.

At step 704, the controller 202 receives belt condition baseline data based at least in part on the one or more sensors. The belt condition baseline data includes data related to one or more belt conditions in a desired state. For example, belt condition baseline data may include image data that shows images of portions of a draper belt in a desired state. For example, the image data may include image data for one or more portions of a draper in various states of wear but in desirable operational conditions. In some examples, the image data may include data related to surface condition including markings and coloration. In some examples, baseline data may include data related to other draper condition indicators. For example, baseline data may include data such as rotation speed of the draper belt or vibration data from the draper belt.

At step 706, the controller 202 determines a belt active condition based at least in part on the belt baseline data and belt operation data. In some examples, the active condition may be a condition that the controller 202 determines is desired for continued operation in a current state. In some examples, the controller 202 may determine that the belt active condition is an undesired condition. The controller 202 may compare the belt baseline data and the belt operation data to determine differences between the belt baseline data and belt operation data and identify the belt active condition. In some examples, the controller 202 may determine that one or more discrepancies between the belt baseline data and belt operation data may be an indication of one or more belt active conditions e.g., tears, growth, deformation, etc.). For example, the controller 202 may determine that one or more differences in coloration may be an indication of an undesired belt operating condition. In some examples, the controller 202 may determine that optical indication regarding a tear or warping may be an indication of an active condition.

The controller 202 may be configured to initiate a plurality of routines for belt monitoring and for identifying the active condition at a set time and/or over a period of time. In some examples, the controller 202 may provide instructions to inspect the draper belt over predetermined period of time. In some examples, the controller 202 may provide instructions to continuously inspect the draper belt during one or more operations such as harvesting. In some examples, the controller 202 may provide instructions to a user to manually inspect the belt. In some examples, the controller 202 may provide instructions to automatically execute an inspection routine. In some examples, the inspection routine may be carried out during an agricultural operation. In some examples, the inspection routine may be carried when the work machine 10 is out of crop harvesting locations (e.g., on the headlands).

The controller 202 may be configured to initiate a routine to inspect the belt in multiple configurations and locations to improve the inspection vantage point for the optical sensors. For example, the controller 202 may be configured to provide instructions to raise a header, slow the belt speed, and/or position components (e.g., reel) in a non-obstructive position to provide a desired belt exposure to one or more optical sensors.

At step 708, the controller 202 may determine a change in the active condition based at least in part on the belt operation data and the belt baseline data. The controller 202 may determine that the belt operation data has changed with respect to one or more determined aspects of the baseline data. In some examples, the controller 202 may determine no change in the active condition based at least in part on the operation data and the belt baseline data. For example, the operation data may indicate a consistent aspect (e.g., coloration, surface texture, etc.) between one or more active condition data and the baseline data over a period of time. In some examples, the operation data may indicate an inconsistent aspect (e.g., coloration, surface texture, etc.) between one or more active condition data and the baseline data.

At step 710, the controller 202 may adjust one or more belt operation parameters based at least in part on a determination of the change in active condition related to a draper belt. For example, the controller 202 may send a belt alert indicating belt condition, to one or more operators to make an adjustment to operation to address the change in draper belt active condition. The operation may be such that a user may make a remote or non-remote change to the system (e.g., stopping or starting the system, accelerating or decelerating the work machine 10, moving a component, etc.). The controller 202 may also send instructions to components such as the engine or actuators on the work machine 10 to cause the work machine 10 to make the changes to address the change in active condition. For example, the controller 202 may cause the work machine 10 to slow draper belt speed, and/or deactivate a belt causing the work machine 10 to stop rotation of a draper belt.

The controller 202 may alternatively or additionally send instructions to stop and/or start certain components of the work machine 10 to address the change in active condition. For example, if the controller 202 detects a change in active condition that indicates the draper belt may be unsuited for desired continued operation, the system may raise or lower the draper belt to cause the draper belt to disengage from potentially interfacing surfaces and/or objects. However, in some examples, the controller 202 may determine other corrective actions or combinations of actions related to the work machine 10 to address the change in active condition.

In some examples, the work machine 10 may undergo one or more conditions causing the work machine 10 to be misaligned with crop that is intended for harvest in a harvesting operation. In some examples, a crop may be planted having a set number of rows (e.g., 10, 14, 16, 18, etc.). In some examples, the planted crop may be harvested using the work machine 10. In such examples, the work machine 10 may be a combine harvester having a header that has a width to include either greater or fewer rows than the planted rows. In some such examples, the header of the combine harvester may be misaligned with the crop rows for harvesting the complete set of rows, which may cause undesired harvesting conditions. In some examples, a portion of a combine harvester may be non-operational causing the actual harvested portion of a set of crop rows to be limited to the operational portion of the header. In some examples, the controller 202, 302 may be configured to detect such crop misalignment.

Alternatively or additionally, in some examples the controller may be configured to cause the work machine 10 to take corrective action. For example, the controller 202, 302 may be configured to alert/notify an operator onboard and/or a remote supervisor, and/or transmit instructions to one or more of the work machine and/or work machine components to address the crop misalignment. For example, the controller may transmit instructions to one or more portions of the work machine 10 such that the work machine 10 may realign with the crop rows, and/or make additional passes to address harvesting conditions. In some examples, the work machine 10 may be configured to process and plan a desired route to efficiently harvest misaligned crop rows.

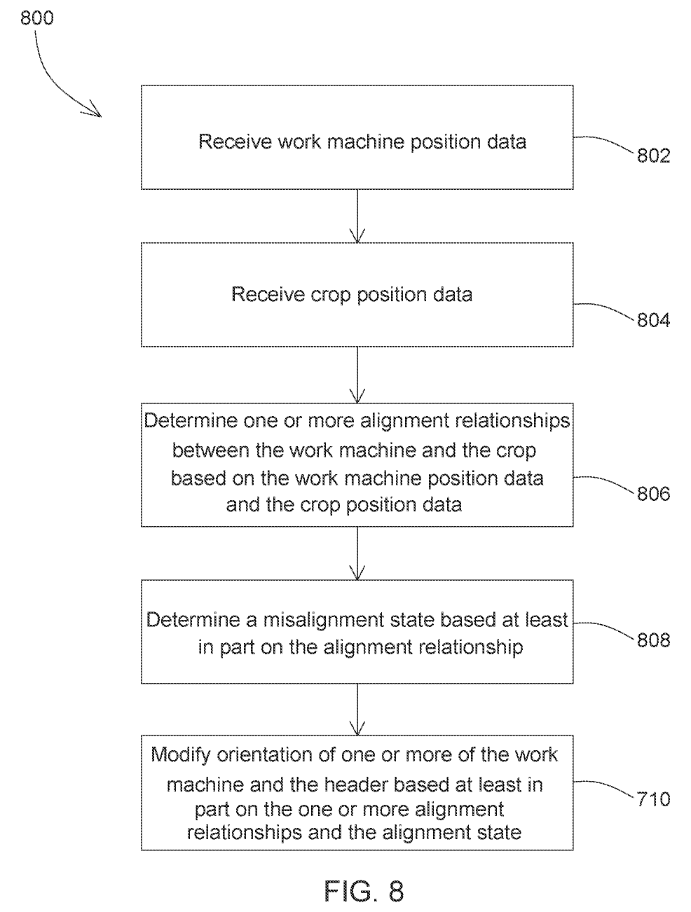

FIG. 8 is a flow chart 800 showing example steps 802-810 for harvest alignment in the work machine 10. The process may be implemented by a system for monitoring a portion of the work machine 10 and/or agricultural field, which may include one or more controllers such as one or more of the controllers 202, 302.

At 802, the controller 202 receives work machine position data. The controller may receive data related to the position of the work machine 10 in a field. For example, the work machine 10 position data may include data related to a work machine angle and/or a header angle with respect to crop (e.g., crop row) during an agricultural operation. The machine position data may be related to a direction of work machine travel during an agricultural operation. In some examples, the work machine position data may include data related to a lateral position with respect to crop.

The data may be received from one or more onboard sensors and/or one or more offboard sensors such as drone or satellite imaging. For example, a work machine general position may be identified by one or more satellite images and the work machine position may also be further determined in relation to other objects on the field by onboard sensors such as camera, lidar, radar to other sensors as described in this application. In some examples, the work machine position data may be based at least in part on one or more data types. For example, the work machine position data may be based at least in part on one or more of optical data (e.g., image data) and/or map data such as field map data.

At 804, the controller 202 may receive crop position data. The crop position data may be provided to determine a position of crop in a field. The crop position data may come from one or more onboard sensors and/or one or more offboard sensors such as drone or satellite imaging. For example, the controller 202 may identify a crop position in a field in which the work machine 10 is operating by using one or more satellite images in combination with one or more sensors located on the work machine 10.

The crop position may be further determined in relation to other objects on the field by onboard sensors such as camera, lidar, radar or other sensors as described in this application. The crop position may include a position of any portion of crop that may be relevant in relationship to the work machine 10 for purposes of a harvesting operation. For example, crop position data may include position of a small portion of crop. Crop position data may alternatively or additionally be crop related to an operation of the work machine 10. Crop position may also include data related to whether crop is being downed and/or harvested as the work machine 10 passes the crop. The crop position data may include data showing that a portion or an entirety of crop that is being passed in a harvesting row is being harvested.

At step 806, the controller 202 determines one or more alignment relationships between the work machine 10 and the crop based on the work machine 10 position data and the crop position data. The controller 202 may relate the work machine position data and the crop position data to each other to determine where in relation to the crop the work machine 10 is located. For example, the work machine 10 may be a combine harvester that may harvest a row of crop. The controller 202 may determine that the combine harvester may be aligned with the row of crop as planted, or the crop may be determined to be aligned with a portion of the row and/or actively harvesting only a portion of a planted row of crop. For example, as described above, a row of crop may be planted using a seeder having a greater number of rows than the width of a header used for harvesting. As such, the controller 202 may determine that the header is not in alignment with the row of crop.

In some examples, a portion of a combine harvester header may not be functional due to an undesired condition. As such, the portion of the header that is not functional may not be harvesting crop and the functional parts of the header may be determined to be misaligned with the entirety of the row to be harvested. As such, the controller 202 may determine an alignment relationship between the work machine 10 and the crop.

At step 808, the controller 202 determines a misalignment state based at least in part on the alignment relationship. The misalignment state may be a determination of the state of the work machine 10 in relation to the crop. For example, the misalignment state may be determined to be aligned, due to an intended alignment with the work machine 10 and harvested crop. In some examples, the misalignment state may be determined to be such that the work machine 10 is misaligned based on an unintended alignment between the work machine 10 and harvested crop.

At step 810, the controller 202 may transmit instructions to modify orientation of one or more of the work machine 10 and /or work machine components (e.g., combine harvester header) based at least in part on the one or more alignment relationships and the alignment state. The controller 202 may adjust one or more operation parameters based at least in part on the determination of the alignment relationship. For example, the controller 202 may send an alert to one or more operators to make an adjustment to operation to address a misaligned determination. The user may make a remote or non-remote change to the system (e.g., stopping or starting the system, accelerating or decelerating the work machine 10, moving a component, etc.). The controller 202 may also send instructions to components such as the engine or actuators on the work machine 10 to cause the work machine 10 to make the changes to address the change in active condition. For example, the controller 202 may cause the work machine 10 to steer in a desired direction to align the work machine 10 with a desired portion of crop.

The controller 202 may provide instructions to change a lateral position and/or heading of the work machine 10 with respect to a direction of travel of the work machine 10 and/or with respect to a row of crop. In some examples, the controller 202 may provide instructions to move the work machine 10 to a desired field position. For example, the controller 202 may provide steering instructions to move the work machine 10 to a position to harvest a portion of a row that is wider than the header. As such, the controller 202 may provide instructions to position the work machine 10 to harvest the non-harvested portion of that row.

In some examples, the controller 202 may provide instructions to align the work machine 10 with a row of crop. For example, the controller 202 may provide alignment instructions such that a desired portion of a header harvests crop. E.g., a functioning portion of a header may be realigned to harvest the crop while a non-functioning portion of the crop header may be aligned to avoid the crop row.

In some examples, the work machine 10 may align with a crop row such that a portion of row that is wider than a width of a header of a work machine 10 may be harvested by the header of the work machine 10. The instructions may also be configured for the work machine 10 to make an additional pass to align a functional portion of a work machine header with missed crop due to a non-functional portion of the header missing the crop. In some examples, the controller 202 may provide instructions to make an additional pass to align a header with a portion of missed crop that has been missed in a pass due to a wider planting area than an area covered by a combine harvester.

The controller 202 may alternatively or additionally provide instructions to stop and/or start certain components of the work machine 10 to address the change in active condition. For example, if the controller 202 detects a misalignment state indicative of an unwanted misalignment condition, the controller may cause the work machine 10 to stop the operation such that a user may take manual corrective action to adjust the work machine 10 to a desired state and/or alignment.

In some examples, the work machine 10 having a folding header may be configured to fold and unfold the header under desired conditions. In some examples, the desired conditions may be one or more desired times and/or at one or more desired locations. In such examples, it may be beneficial to identify and verify a fold state of the header to determine whether that the header is in a desired state when intended – such as completed unfolded and in the operable configuration to harvest. The work machine 10 may detect undesired stowed or deployed conditions. The controller 202 may be further configured to provide one or more actions and/or instructions to address the condition of the header (e.g., stow or deploy the header as desired).

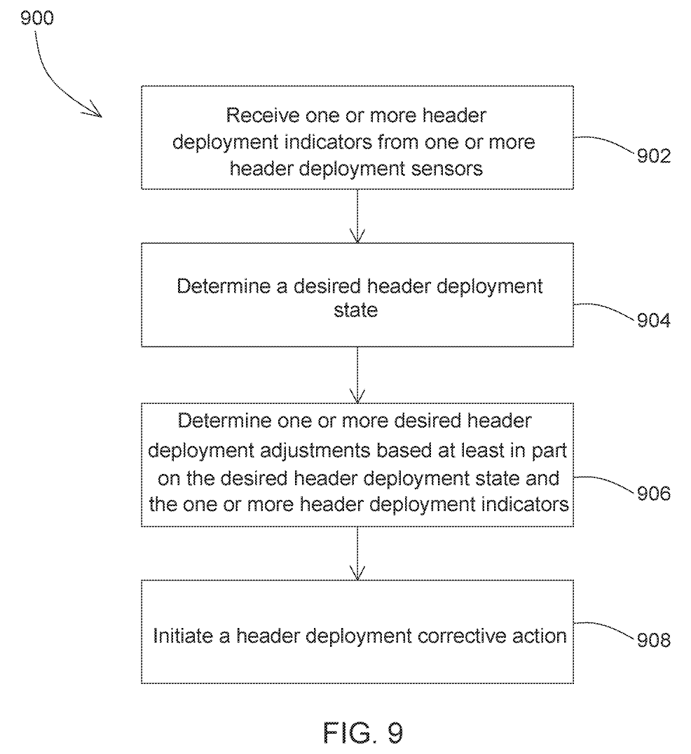

FIG. 9 is a flow chart 900 showing example steps 902-908 for detecting header deployment in the work machine 10. The process may be implemented by a system for monitoring a portion of the work machine 10 and/or agricultural field, which may include one or more controllers such as one or more of the controllers 202, 302.

At step 902 the controller 202 receives one or more header deployment indicators from one or more header deployment sensors. The one or more header deployment indicators may be data that is indicative of a header deployment state such as a deployed state or a stowed state. For example, the header deployment data may be one or more of optical and/or image data, switch/circuit activation data, or other indications of deployment or stowing of the work machine 10 including the header (e.g., actuator position, position detection, or component orientation sensors).

In some examples, the controller 202, may determine that one or more objects (e.g., non-crop objects) may be present in a region about where the header may deploy. In such examples, the controller 202, may be configured to detect the one or more non-crop objects based on one or more sensor readings. In some such examples, the controller may determine one or more types of detected objects. In some examples, the determination of the one or more detected objects may be based on one or more attributes (e.g., object shape, size, orientation, location, proximity/distance, quantity, specific object identification, etc.). In some examples, the controller 202 may determine corrective action to prevent the header from interacting with the one or more non-crop objects.

In some examples, a combination of data sources may be used to determine a stowed state or a deployed state. For example, the work machine 10 may activate one or more internal switches to provide an indication when the header is in a stowed position. One or more optical sensors may provide optical data which may be used to optically sense stowed or deployed state in conjunction with the indication from the switch to confirm the state of the header (e.g., deployed or stowed).

At step 904, the controller 202 may determine a desired header deployment state based on one or more indicators of a desired header deployment state. For example, an intended deployment state may be indicated by a user choice on a menu, by a predetermined time for deployment or stowing, and/or by an intended stowing and deployment position and/or location. For example, in examples related to an automated work machine 10 and/or partially automated work machine 10, the controller 202 may determine that the work machine 10 is entering a location of a field where there is an intent to harvest crop.

The controller 202 may determine that this location is an intended deployment position. In some examples the controller 202 may determine that the work machine 10 is exiting a part of a field where there is intent for the work machine 10 to harvest crop. In such examples, the controller 202 may determine that the header should be in a stowed state. In some examples, the controller may determine that the work machine 10 will soon be loaded onto a transport vehicle. The controller may further determine that the header should be in a stowed state. In other examples, the work machine 10 may be unloaded from a transport vehicle such that the controller 202 may determine that the header should be in a deployed state.

In some examples, the desired header deployment state may be based at least in part on the presence of an object such as a non-crop object in a path of interference with the header. For example, the controller may determine that a non-crop object is in an area that the header may deploy into and/or determine that an object may obstruct a travel path of the header during stowing. In some examples, the controller may determine the desired header deployment state based at least in part on the attributes of the detected object that is determined to obstruct the header travel path (e.g., size, orientation, location, proximity/distance, quantity, specific object identification, etc.).

At step 906, the work machine 10 may determine one or more desired header deployment adjustments based at least in part on the one or more header deployment indicators and the one or more desired header deployment states. In some examples, the controller 202 may determine that the header should be deployed but is not in a deployed state. In such examples, the controller 202 may determine that a desired corrective action may be to deploy the header. In some examples the controller 202 may determine that the header is in a deployed state and should not be deployed. In such examples, the desired corrective action may be to move the header to a stowed state.

In some examples, the desired header deployment adjustments may be based on one or more sensor reading confirmations. For example, in some examples the controller 202 may determine header deployment adjustments based at least in part on a switch reading that does not agree with a visual indication reading. As such, the controller 202 may further determine the intended position based on other aspects such as position, operation time, and/or user input.

At step 908, the controller 202 initiates a header deployment corrective action. The header deployment corrective action may include providing an alert and/or automated action. In some examples, the corrective action may include activating and/or deactivating one or more functions of the header. For example, the corrective action may include deactivating header component motion such as reel motion, cutter bar motion, and/or belt motion. In some examples, the header deployment corrective action may be to deploy or stow the header. For example, the controller 202 may determine to deploy or stow the header if the header is not in the intended deployed or stowed state.

The controller 202 may provide instructions to activate one or more header closing mechanisms, and/or one or more header extension mechanisms (e.g., activating and/or controlling one or more actuators). In some examples, the header may be folded and/or unfolded laterally and/or in a fore-aft direction with respect to a direction of motion in an agricultural operation. The header deployment corrective action may be to execute a routine to deploy a transport state and return the work machine 10 to the harvest state. For example, the corrective action may be to stow the header if it is determined that the header is not in the intended harvest state. The controller 202 may send one or more signals to actuators and/or systems of the work machine 10 such as systems within the header, to activate actuators to move the header between a deployed and a stowed position.

As described above, in some examples the deployment state may be based at least in part on the presence of an obstruction in a path of interference with the header. In some such examples, the corrective action may include providing an alert regarding the obstruction and/or stopping and/or preventing movement of the header to avoid interacting with the obstruction in a path of interference with the header. In some examples where the controller 202 may determine a type of obstruction, the controller 202, may provide instructions based on the type of obstruction detected (e.g., type of alert, speed of actuation/stop, etc.).

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described examples.

While the above describes example examples of the present disclosure, these descriptions should not be viewed in a limiting sense. Rather, other variations and modifications may be made without departing from the scope and spirit of the present disclosure as defined in the appended claims.

The foregoing description and examples have been set forth merely to illustrate the disclosure and are not intended as being limiting. Each of the disclosed aspects and examples of the present disclosure may be considered individually or in combination with other aspects, examples, and variations of the disclosure. In addition, unless otherwise specified, none of the steps of the methods of the present disclosure are confined to any particular order of performance. Modifications of the disclosed examples incorporating the spirit and substance of the disclosure may occur to persons skilled in the art and such modifications are within the scope of the present disclosure. Furthermore, all references cited herein are incorporated by reference in their entirety.

Terms of orientation used herein, such as “top,” “bottom,” “horizontal,” “vertical,” “longitudinal,” “lateral,” and “end” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that may be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures but may encompass structures that are reasonably close approximations.

Conditional language used herein, such as, among others, “can,” “might,” “may,” “e.g.,” and the like, unless specifically stated otherwise, or otherwise understood within the context as used, is generally intended to convey that some examples include, while other examples do not include, certain features, elements, and/or states. Thus, such conditional language is not generally intended to imply that features, elements, blocks, and/or states are in any way required for one or more examples or that one or more examples necessarily include logic for deciding, with or without author input or prompting, whether these features, elements and/or states are included or are to be performed in any particular example.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” may refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices may be collectively configured to carry out the stated recitations. For example, “a processor configured to carry out recitations A, B, and C” may include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive examples and examples that are illustrated and described in this disclosure, or that are discussed during the prosecution of the application.

Although systems and methods for detecting and addressing work machine conditions have been disclosed in the context of certain examples and examples, this disclosure extends beyond the specifically disclosed examples to other alternative examples and/or uses of the examples and certain modifications and equivalents thereof. Various features and aspects of the disclosed examples may be combined with or substituted for one another in order to form varying modes of systems and methods for detecting and addressing work machine conditions. The scope of this disclosure should not be limited by the particular disclosed examples described herein.

Certain features that are described in this disclosure in the context of separate examples may be implemented in combination in a single example. Conversely, various features that are described in the context of a single example may be implemented in multiple examples separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various examples described and the appended claims. Further, the disclosure herein of any particular feature, aspect, method, property, characteristic, quality, attribute, element, or the like in connection with an example may be used in all other examples set forth herein. Any methods disclosed herein need not be performed in the order recited. Depending on the example, one or more acts, events, or functions of any of the algorithms, methods, or processes described herein may be performed in a different sequence, may be added, merged, or left out altogether (e.g., not all described acts or events are necessary for the practice of the algorithm). In some examples, acts or events may be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each example. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some examples may be performed using the sequence of operations described herein, while other examples may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described may be incorporated in the example methods and processes. For example, one or more additional operations may be performed before, after, simultaneously, or between any of the described operations. Further, the operations may be rearranged or reordered in other examples. Also, the separation of various system components in the examples described herein should not be understood as requiring such separation in all examples, and it should be understood that the described components and systems may generally be integrated together in a single product or packaged into multiple products. Additionally, other examples are within the scope of this disclosure.

Some examples have been described in connection with the accompanying figures. Certain figures are drawn and/or shown to scale, but such scale should not be limiting, since dimensions and proportions other than what are shown are contemplated and are within the scope of the examples disclosed herein. Distances, angles, etc. are merely illustrative and do not necessarily bear an exact relationship to actual dimensions and layout of the devices illustrated. Components may be added, removed, and/or rearranged. Further, the disclosure herein of any particular feature, aspect, method, property, characteristic, quality, attribute, element, or the like in connection with various examples may be used in all other examples set forth herein.

What is claimed is:

1. A method for detecting header deployment in a work machine comprising:
receiving one or more header deployment indicators from one or more header deployment sensors;
determining a desired header deployment state;
determining one or more desired header deployment adjustments based at least in part on the desired header deployment state and the one or more header deployment indicators; and
initiating a header deployment corrective action.

2. The method of claim 1, wherein the header deployment corrective action comprises adjusting header deployment to one or more header deployment positions based at least in part on the one or more desired header deployment adjustments.

3. The method of claim 1, wherein the header deployment corrective action comprises initiating an alert.

4. The method of claim 1, wherein the header deployment corrective action comprises deactivating header component motion.

5. The method of claim 1, wherein the one or more header deployment indicators comprises image data.

6. The method of claim 1, wherein determining the header deployment state further comprises sensing the deployment state in a stowed position or a deployed position by one or more sensors.

7. The method of claim 1, wherein receiving the one or more header deployment indicators comprises receiving indication of one or more obstructions.

8. The method of claim 1, wherein adjusting header deployment comprises activating one or more of a header closing mechanism and a header extension mechanism.

9. The method of claim 1, wherein adjusting header deployment comprises laterally folding the header.

10. The method of claim 1, wherein adjusting header deployment comprises folding the header in a fore-aft direction.

11. A system for detecting header deployment in a work machine, the system comprising:
one or more controllers configured to:
receive one or more header deployment indicators from one or more header deployment sensors;
determine a desired header deployment state;
determine one or more desired header deployment adjustments based at least in part on the desired header deployment state and the one or more header deployment indicators; and
initiate a header deployment corrective action.

12. The system of claim 11, wherein the header deployment corrective action comprises adjusting header deployment to one or more header deployment positions based at least in part on the one or more desired header deployment adjustments.

13. The system of claim 11, wherein the header deployment corrective action comprises initiating an alert.

14. The system of claim 11, wherein the header deployment corrective action comprises deactivating header component motion.

15. The system of claim 11, wherein the one or more header deployment indicators comprises image data.

16. The system of claim 11, wherein to determine the header deployment state further comprises to optically sense the deployment state in a stowed position or a deployed position.

17. The system of claim 11, wherein to receive the one or more header deployment indicators comprises to receive indication of one or more obstructions.

18. The system of claim 11, wherein to adjust header deployment comprises to activate one or more of a header closing mechanism and a header extension mechanism.

19. The system of claim 11, wherein to adjust header deployment comprises to laterally fold the header.

20. The system of claim 11, wherein to adjust header deployment comprises to fold the header in a fore-aft direction.
